(19) United States
(12) Patent Application Publication
(10) Pub. No.: US 2026/0316599 A1
(43) Pub. Date: Oct. 15, 2026

(54) AUTOMOTIVE VEHICLE WITH A CHARGING UNIT UNDER AT LEAST ONE SEAT

(71) Applicant: FLEXIS, BOULOGNE-BILLANCOURT (FR)

(72) Inventor: Michael CAUDRON, VILLIERS-SAINT-FREDERIC (FR)

(21) Appl. No.: 19/644,556

(22) Filed: Apr. 10, 2026

(30) Foreign Application Priority Data
Apr. 14, 2025 (FR) FR2503947

(51) Int. Cl. B60L 50/60; B60K 1/02; B60K 1/04; B60L 50/71; B60L 50/75; B60N 2/005

(52) U.S. Cl. CPC B60L 50/66; B60K 1/02; B60K 1/04; B60L 50/71; B60L 50/75; B60N 2/005; B60K 2001/0422; B60L 2210/10

(57) ABSTRACT

An automotive vehicle includes: a body delimiting a passenger compartment, wherein the body includes a floor with an upper face oriented toward the passenger compartment and a lower face opposite the upper face according to a vertical direction, wherein the floor includes a corrugation; at least one seat arranged in the passenger compartment and fixed to the upper face of the floor, wherein the corrugation extends under the seat; a traction battery; and a charging unit arranged, according to the vertical direction, between the traction battery and the lower face of the corrugation of the floor. The charging unit includes a charger and a DC/DC converter.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure relates to an automotive vehicle, notably an electric vehicle, and in particular comprising a charging unit arranged under at least one seat.

### BACKGROUND

Commercial vehicles, in particular light vehicles such as vans, are increasingly used, in particular in cities, for example to ensure parcel and/or goods deliveries.

In order to ensure satisfactory maneuverability of such vehicles, notably in narrow urban spaces, it is preferable to design such vehicles with a reduced front overhang.

Nevertheless, such a reduction in the overhang greatly reduces the space available for arranging equipment, such as the charging unit, at the front of the vehicle.

Furthermore, to adapt to different specific uses, it is known to manufacture vehicles with specific adaptations, for example with four-wheel drive or equipped with a fuel cell.

However, such adaptations generally require the addition of extra equipment, consequently leading to major modifications of the overall vehicle architecture.

### SUMMARY

One of the aims of the present disclosure is to find a compromise between these two constraints, and notably to propose a vehicle with a charging unit arranged so as to ensure a reduced front overhang and presenting an architecture suitable for different alternatives of the vehicle.

To this end, the present disclosure has as its object, an automotive vehicle, notably an electric vehicle, comprising:
a body delimiting a passenger compartment, the body comprising a floor with an upper face oriented toward the passenger compartment and a lower face opposite the upper face according to or along a vertical direction, the floor comprising a corrugation,
at least one seat arranged in the passenger compartment and fixed to the upper face of the floor, the corrugation extending under the seat
a traction battery, and
a charging unit arranged, according to or along the vertical direction, between the traction battery and the lower face of the corrugation of the floor.

The charging unit comprises a charger and a DC/DC converter.

According to other advantageous aspects of the present disclosure, the vehicle comprises one or more of the following features, taken alone or according to all technically possible combinations:
The charging unit comprises, in addition, high-voltage cabling, electrically connecting the charger and the traction battery.
The charging unit comprises, in addition, a cooling circuit.
The charging unit comprises a mounting bracket fixing the charging unit to the lower face of the floor.
The corrugation presents an inverted U-shaped cross-section.
The vehicle comprises, in addition, a front motor compartment, a rear motor compartment and a motor arranged in the rear motor compartment.
The vehicle comprises, in addition, a second motor arranged in the front motor compartment.
The vehicle comprises, in addition, a fuel cell arranged in the front motor compartment.
The vehicle comprises, in addition, hydrogen tanks for supplying the fuel cell.
The at least one seat is a front seat of the vehicle.

### BRIEF DESCRIPTION OF THE DRAWINGS

The present disclosure will appear more clearly upon reading the following description, given solely by way of non-limiting example, and made with reference to the drawings in which:

FIG. 1 is a schematic side view of a first vehicle according to the present disclosure,

FIG. 2 is a schematic underside view of the first vehicle of FIG. 1,

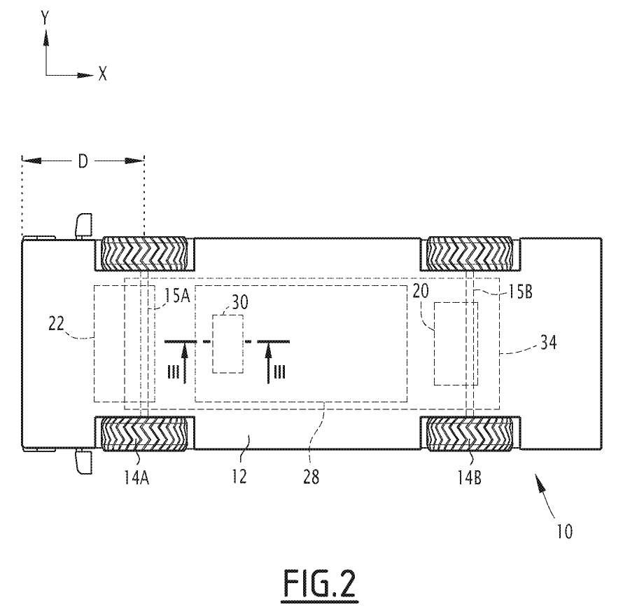

FIG. 3 is a sectional view of the first vehicle of FIG. 2, and

FIG. 4 is a schematic underside view of a second vehicle according to the present disclosure.

### DETAILED DESCRIPTION

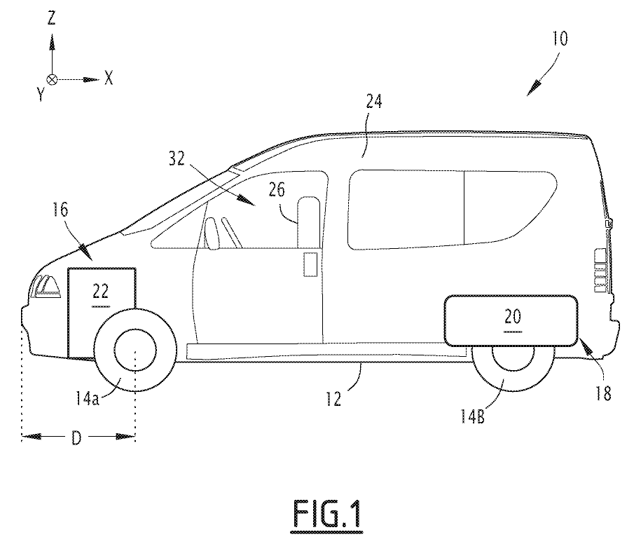

FIG. 1 shows a first vehicle 10 according to the present disclosure, and in particular a vehicle 10 according to a first embodiment of the present disclosure.

The vehicle 10 is for example an automotive vehicle, in particular a commercial vehicle, notably a light commercial vehicle.

In particular, the vehicle 10 is intended for transporting goods, such as parcels, and/or passengers.

The vehicle 10 is for example a van, as illustrated in FIG. 1.

For clarity, an orthonormal XYZ frame is defined as comprising a longitudinal direction X, a transverse direction Y and a vertical direction Z. The longitudinal direction X extends according to the axis of travel of the vehicle 10 and corresponds to a front-rear axis of the vehicle 10. The transverse direction Y is perpendicular to the longitudinal direction X and corresponds to a left-right axis of the vehicle 10. The vertical direction Z is perpendicular to the longitudinal direction X and to the transverse direction Y and corresponds to a down-up axis of the vehicle 10.

The terms “top” and “bottom” are defined relative to the vertical direction Z corresponding to the height of the vehicle. The terms “left”, “right”, “front” and “rear” are defined relative to the usual direction of travel of the vehicle.

The vehicle 10 is preferably an electric vehicle.

The vehicle 10 is for example a four-wheel-drive vehicle, commonly called a “4x4 vehicle”.

For example, the vehicle 10 comprises a chassis 12, notably of the “skateboard platform” type, and four wheels 14A, 14B, in particular driven wheels.

In particular, the chassis 12 comprises for example a flat structure resembling a skateboard deck, intended to support all the mechanical and electronic components essential for propulsion and control of the vehicle.

The four wheels comprise notably two front wheels 14A and two rear wheels 14B.

The wheels 14A, 14B are in particular mounted on axles 15A, 15B. More precisely, the two front wheels 14A are mounted on a front axle 15A and the two rear wheels 14B are mounted on a rear axle 15B.

Preferably, the wheels 14A, 14B are, for example, connected to the chassis 12 via a suspension system.

As can be seen in FIG. 1, the vehicle 10 comprises, for example, a front motor compartment 16, notably arranged at the front of the vehicle 10, and a rear motor compartment 18, notably arranged at the rear of the vehicle 10.

The vehicle 10 comprises for example, at least one motor 20, which is notably an electric motor.

The motor 20 is notably a rear motor, in particular arranged in the rear motor compartment 18.

The rear motor 20 is preferably responsible for driving the rear axle 15B in rotation.

In a particular embodiment where the vehicle 10 is a 4x4 vehicle, the vehicle 10 comprises, preferably, a second motor 22, which is also notably an electric motor.

The second motor 22 is notably a front motor, in particular arranged in the front motor compartment 16.

The second motor 22 is preferably responsible for driving the front axle 15A in rotation.

The vehicle 10 advantageously presents a reduced front overhang, corresponding to the distance D between the axis of the front wheels 14A of the vehicle 10 and a front end of the vehicle 10.

For example, the front overhang is between 600 and 900 mm, and notably substantially equal to 750 mm.

The vehicle 10 comprises a body 24, at least one seat 26, a traction battery 28 and a charging unit 30.

The body 24 is for example fixed to the chassis 12.

The body 24 delimits a passenger compartment 32 of the vehicle.

In particular, the passenger compartment 32 here designates the interior space intended for passengers.

The body 24 comprises for example a plurality of structural parts, such as pillars or body panels for example.

The body 24 comprises a floor 34.

The floor 34 delimits for example the lower part of the passenger compartment 32.

In particular, the floor 34 extends notably facing the chassis 12, and in particular, between the chassis 12 and the passenger compartment 32 according to the vertical direction Z.

The floor 34 presents an upper face 36 and a lower face 38 opposite the upper face 36 according to the vertical direction Z.

The upper face 36 is oriented toward the passenger compartment 32, and notably toward the top.

The lower face 38 is oriented toward the ground, and for example in the direction of the chassis, and notably toward the bottom according to the vertical direction Z.

The floor 34 comprises a corrugation 40.

For example, the corrugation 40 extends according to the longitudinal direction X between two flat portions 42 of the floor 34.

More precisely, the corrugation 40 defines a portion of the floor 34 according to the longitudinal direction X.

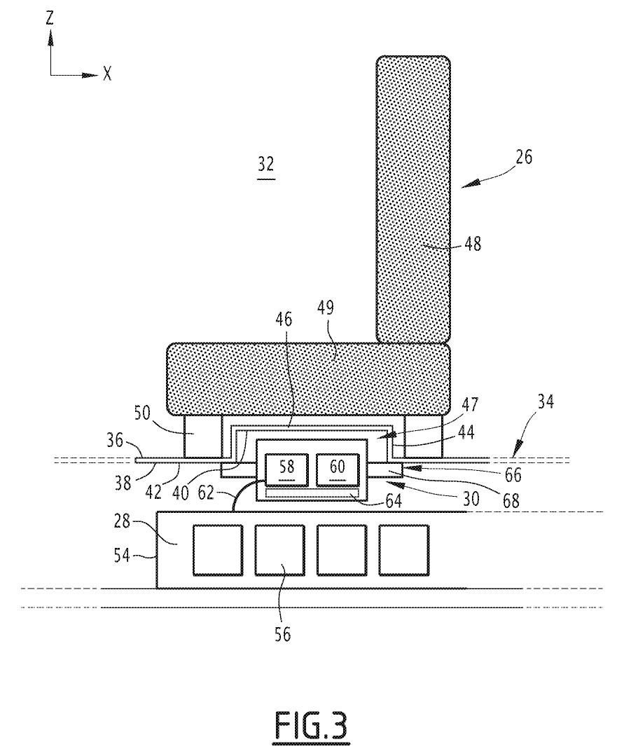

The corrugation 40 presents, for example, an inverted U-shaped cross-section, as is visible in FIG. 3. The cross-section is notably defined in the plane XZ.

Preferably, the corrugation 40 defines a receiving space 47.

In particular, the corrugation 40 comprises for example two vertical sides 44, notably extending toward the top, connected to each other by a horizontal side 46, so as to advantageously define the receiving space 47 beneath it.

The two flat portions 42 extend notably in the plane XY.

Each of the two flat portions 42 is for example connected to one of the vertical sides 44 of the corrugation 40.

The seat 26 is arranged in the passenger compartment 32.

The seat 26 is for example a front seat, notably arranged at the front of the vehicle 10.

The seat 26 is, for example, the seat for the driver.

Preferably, the vehicle 10 comprises at least two seats 26, in particular a seat for the driver and a front passenger seat.

The, or each seat 26 comprises for example a backrest 48 and a seat portion 49, as visible, notably in FIG. 3.

For example, the, or each seat 26 comprises two mounting crossmembers 50, each notably extending according to the transverse direction Y under the seat portion 49.

The, or each seat 26 is fixed on the floor 34, and notably on the upper face 36 of the floor 34, the corrugation 40 extending under the seat 26.

For example, each mounting crossmember 50 of the corresponding seat 26 is fixed on the upper face 36 of the floor 34, and notably such that the seat portion 49 extends above the corrugation 40.

As is visible in FIG. 3, the receiving space 47 extends preferably under the seat 26, and notably under the seat portion 49.

The traction battery 28 is preferably able to store the energy required to supply the motor 20 and/or the second motor 22.

The traction battery 28 presents, for example, a voltage at the terminals of 800 V.

For example, the traction battery 28 comprises a metallic casing 54 and electrochemical cell modules 56.

For example, the metallic casing 54 defines a protective enclosure in which the modules 56 are housed.

The casing 54 presents for example a rectangular parallelepiped shape.

The traction battery 28, and more precisely the casing 54, is notably fixed to the chassis 12.

In particular, the traction battery 28 is arranged, according to the vertical direction Z, between the floor 34 and the chassis 12.

As is visible in FIG. 3, the traction battery 28 is, for example, arranged against an upper face of the chassis 12 and facing the lower face 38 of the floor 34, notably at a distance therefrom.

The charging unit 30 comprises at least one charger 58 and a DC/DC converter 60.

Preferably, the charging unit 30 comprises at least one from among high voltage cabling 62, a cooling circuit 64 and a mounting bracket 66.

The charging unit 30 preferably forms a block.

In other words, all the components of the charging unit 30 are assembled together and are more particularly integral with one another.

As is visible in FIG. 3, the charging unit 30 is arranged, according to the vertical direction Z, between the traction battery 28 and the lower face 38 of the floor 34, and notably of the corrugation 40.

More particularly, the charging unit 30 is arranged at least partially in the receiving space 47, notably under the seat(s) 26.

The charger 58 is, for example, intended to convert electrical energy coming from an external source, such as a wall outlet or a charging station, into energy stored in the traction battery 28.

Advantageously, the charger 58 is connected to the traction battery 28 by the high voltage cabling 62.

The DC/DC converter 60 is for example connected to the charger 58.

The DC/DC converter 60 is for example able to convert a direct-current (DC) voltage from one level to another.

In particular, the DC/DC converter 60 is a voltage converter configured to supply electrical components of the vehicle 10 operating at a specific voltage.

For example, the charging unit 30 is configured to simultaneously supply the air-conditioning compressors and the electric heating unit of the vehicle 10.

The cooling circuit 64 is notably able to prevent overheating of the charger 58 and/or the DC/DC converter 60.

Preferably, the mounting bracket 66 fixes the charging unit 30 to the lower face 38 of the floor 34.

For example, the mounting bracket 66 comprises at least two fasteners 68.

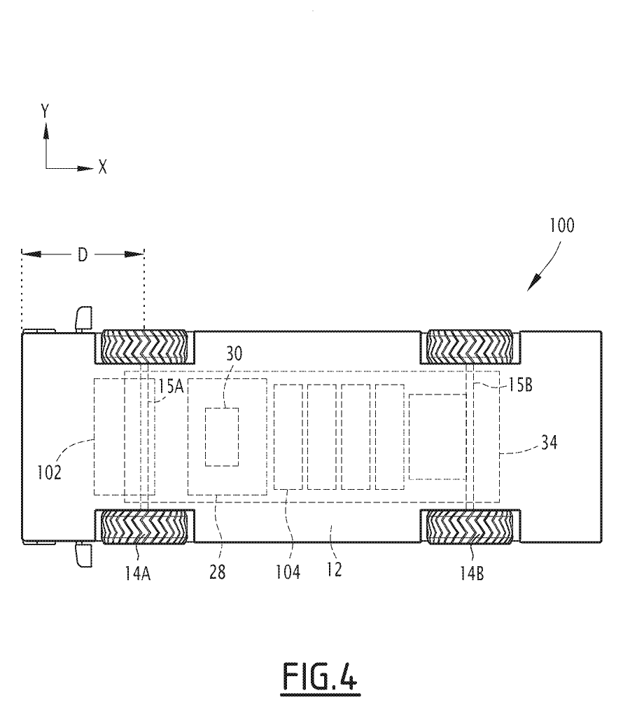

FIG. 4 shows the underside of a second vehicle 100 according to the present disclosure, and in particular, a vehicle 100 according to a second embodiment of the present disclosure.

This second vehicle 100 differs from the first vehicle 10 described above only in that this second vehicle 100 is not a 4x4 vehicle, but a hydrogen vehicle.

In particular, the second vehicle 100 does not comprise a second motor 22 arranged in the front motor compartment 16.

The second vehicle 10 preferably comprises a fuel cell 102, in particular arranged in the front compartment 16.

The second vehicle 100 also comprises for example hydrogen tanks 104 for supplying the fuel cell 102.

These tanks 104 are for example arranged facing the lower face 38 of the floor 34 and are in particular fixed to the chassis 12.

The tanks 104 are, for example, cylinders containing hydrogen, notably compressed in gaseous form, and intended to supply the fuel cell 102.

Such vehicles 10, 100 are particularly advantageous.

In particular, such an arrangement of the charging unit 30 allows to avoid placing it in the front motor compartment 16.

The size of the front motor compartment 16 thus remains reduced, which allows to ensure a reduced overhang.

Furthermore, such an arrangement of the charging unit 30 is suitable for different vehicle alternatives, notably a 4x4 vehicle or a hydrogen vehicle.

Indeed, the general architecture is preserved between these two vehicles 10, 100, notably thanks to the arrangement of the charging unit 30 outside the front compartment 16, which makes it possible to arrange specific elements (second motor 22 or fuel cell 102) of these alternatives therein.

What is claimed is:

1. An automotive vehicle comprising:
a body delimiting a passenger compartment, the body comprising a floor with an upper face oriented toward the passenger compartment and a lower face opposite the upper face according to a vertical direction, the floor comprising a corrugation;
at least one seat arranged in the passenger compartment and fixed to the upper face of the floor, the corrugation extending under the at least one seat;
a traction battery; and
a charging unit arranged, according to the vertical direction, between the traction battery and the lower face of the corrugation of the floor, the charging unit comprising a charger and a DC/DC converter.

2. The automotive vehicle according to claim 1, wherein the automotive vehicle is an electric vehicle.

3. The automotive vehicle according to claim 1, wherein the charging unit further comprises high-voltage cabling electrically connecting the charger and the traction battery.

4. The automotive vehicle according to claim 1, wherein the charging unit further comprises a cooling circuit.

5. The automotive vehicle according to claim 1, wherein the charging unit comprises a mounting bracket fixing the charging unit to the lower face of the floor.

6. The automotive vehicle according to claim 1, wherein the corrugation presents an inverted U-shaped cross-section.

7. The automotive vehicle according to claim 1, further comprising a front motor compartment, a rear motor compartment and a motor arranged in the rear motor compartment.

8. The automotive vehicle according to claim 7, further comprising a second motor arranged in the front motor compartment.

9. The automotive vehicle according to claim 7, further comprising a fuel cell arranged in the front motor compartment.

10. The automotive vehicle according to claim 9, further comprising hydrogen tanks for supplying the fuel cell.

11. The automotive vehicle according to claim 1, wherein the at least one seat is a front seat of the automotive vehicle.
